(19) United States
(12) Patent Application Publication
(10) Pub. No.: US 2007/0284946 A1
(43) Pub. Date: Dec. 13, 2007

(54) Passive Power Combiner for Dual Power over Ethernet Sources

(76) Inventor: Steven Andrew Robbins, (US)

Correspondence Address: Steve Robbins, Unit A, 26007 Alizia Canyon Drive, Calabasas, CA, 91302, US

(21) Appl. No.: 11/539,616

(22) Filed: Oct. 6, 2006

Related U.S. Application Data
(60) Provisional application No. 60/804,434, filed on Jun. 10, 2006.

(51) Int. Cl. H02J 1/00

(52) U.S. Cl. 307/18

(57) ABSTRACT

The invention includes a method and apparatus, each with several embodiments, for combining power from two ports of a multi-port Power Sourcing Equipment (PSE) for Power over Ethernet (PoE) systems, for the purpose of providing increased power to a Powered Device (PD) that comprises two separate loads and requires two sources of power.

### CROSS-REFERENCE TO RELATED APPLICATIONS

This application claims priority from U.S. Provisional Patent Application No. 60804434 titled A Passive Combiner for PoE Power Sources, filed on Jun. 10, 2006.

### TECHNICAL FIELD OF THE INVENTION

The invention relates generally to the field of Power over Ethernet (PoE)—a system that provides limited DC power over computer networking cables—and more specifically to the subject of providing increased power for PoE applications.

### BACKGROUND OF THE INVENTION

The IEEE issued an amendment to IEEE Std 802.3™-2002; this amendment, titled Data Terminal Equipment (DTE) Power via Media Dependent Interface (MDI), was published as IEEE Std 802.3af™-2003, and is hereinafter referred to as the “IEEE standard”. The IEEE standard, whose contents are incorporated herein by reference, is commonly referred to as Power over Ethernet (PoE), and specifies methods and requirements for delivery of limited DC power using two of the four twisted-pairs contained within standard Ethernet cables. Equipment that supplies power on Ethernet cables are called Power Sourcing Equipment (PSE), of which there are two types, endspan and midspan, distinguishable by their location within the link segment. Any apparatus that utilizes power supplied by a PSE is called a Powered Device (PD).

The IEEE standard places a limit on the maximum power that can be delivered to a PD on a single Ethernet cable, and this limit has been an impediment to some new PoE application that require more power. Hence, the IEEE, et al. has worked on methods to significantly increase the power available in PoE systems, while maintaining backward compatibility with 802.3af equipment.

One such method for increasing power is illustrated by the block diagram shown in FIG. 1 where system 10 includes an endspan PSE 11 and midspan PSE 12 working in tandem to power a new type of PD 14. The PD 14 essentially comprises two standard PD's within one unit, and is hereinafter referred to as a “dual-load PD”. (The endspan PSE 11 includes a plurality of port circuits 13, and the midspan PSE 12 includes a plurality of port circuits 15; however for simplicity only one port circuit is shown in each PSE.) By utilizing both kinds of PSE in one system 10, increased power is available to the dual-load PD 14 because all four twisted-pairs in the network cable carry current. (The network cable includes a first set of two twisted-pairs 17 and a second set of two twisted-pairs 18.)

While this method essentially doubles the power available to a PD, the major disadvantage is that it requires two PSE, for example an endspan and a midspan, to fully power a dual-load PD. Therefore, users who own an endspan PSE would need to purchase a midspan PSE in order to power a dual-load PD.

### SUMMARY OF THE INVENTION

Accordingly, it is a principle objective of the present invention to overcome the disadvantages of prior art. This is provided in the present invention by a method and apparatus for passively combining power from two ports included within a single PSE. Thus, the present invention offers users a much lower-cost alternative compared to the prior art, by eliminating the need to purchase a second PSE.

The invention includes a method and an apparatus with several embodiments described below.

The method includes steps of: conducting common-mode DC power from a first PSE port to a first load within a PD; conducting DC power from a second PSE port to a second load within the PD; blocking the flow of DC power between the two PSE ports; transferring differential-mode data signals bidirectionally between the first PSE port and the PD; and isolating differential-mode data signals from the second PSE port.

The apparatus includes: a first connector that interfaces to a first PSE port; a second connector that interfaces to a network cable; a third connector that interfaces to a second PSE port; and circuitry that DC-couples power from both the first and third connectors to the second connector, while blocking DC power flow between the first and third connectors. The circuitry also AC-couples differential-mode data signals between the first and second connectors, while preventing differential-mode data signals on the third connector interface from interfering with data flow between the first and second connectors. The circuitry is also adapted to not interfere with the detection, classification, or PD-disconnect-sensing processes defined by the IEEE standard.

The IEEE standard requires a midspan PSE to use Alternative-B wiring (hereinafter referred to as Alt-B), while an endspan PSE may use either Alternative-A (hereinafter referred to as Alt-A) or Alt-B wiring. Accordingly there are two similar electrical embodiments of the invention: an “Alt-A combiner” for PSE that utilize Alt-A wiring, and an “Alt-B combiner” for PSE that utilize Alt-B wiring. In another embodiment, the Alt-A combiner and Alt-B combiner are merged into a single “universal” combiner that can be used with any type of PSE.

### BRIEF DESCRIPTION OF THE DRAWINGS

For a more complete understanding of the invention and to show how the same may be carried into effect, reference will now be made, purely by way of example, to the accompanying drawings:

FIG. 1 shows a block diagram of a conventional PoE system, wherein an endspan PSE and midspan PSE are used in combination to power a dual-load PD;

FIG. 2 shows a block diagram of a novel PoE system, wherein the present invention allows a dual-load PD to be powered by a single PSE;

FIG. 3 shows a simplified schematic diagram of one embodiment of the present invention;

FIG. 4 shows a simplified schematic diagram of another embodiment of the present invention;

FIG. 5 shows a simplified schematic diagram of yet another embodiment of the present invention;

FIG. 6 shows a schematic for a circuit that injects common-mode power onto network cabling;

FIG. 7 shows a schematic for another circuit that injects common-mode power onto network cabling;

FIG. 8 shows a mechanical embodiment of the present invention; and

FIG. 9 shows another mechanical embodiment of the present invention.

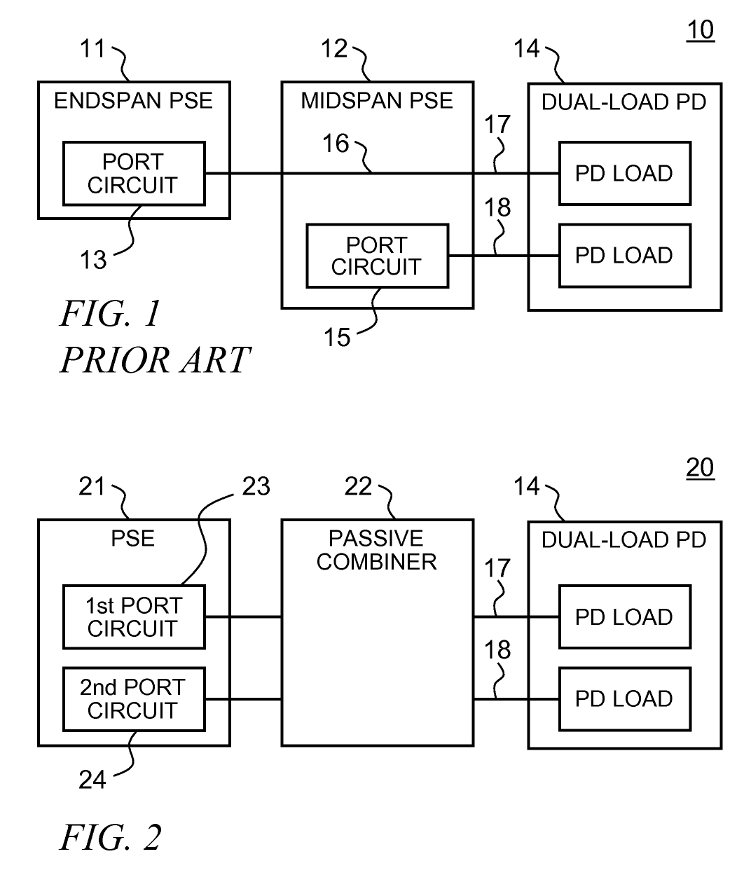

### DETAILED DESCRIPTION OF EXAMPLE EMBODIMENTS OF THE INVENTION

FIG. 2 shows a novel system 20 in accordance with the teachings of the invention. A passive combiner apparatus 22 interfaces to two ports 23 and 24 on the same PSE 21, and combines their outputs onto a single cable such that the first PSE port 23 supplies power to the dual-load PD 14 on the Alt-A pairs 17, and the second PSE port 24 supplies power to the dual-load PD 14 on the Alt-B pairs 18. This allows the dual-load PD 14 to be fully powered without the expense of purchasing two PSE. The PSE 21 can be either an endspan or a midspan.

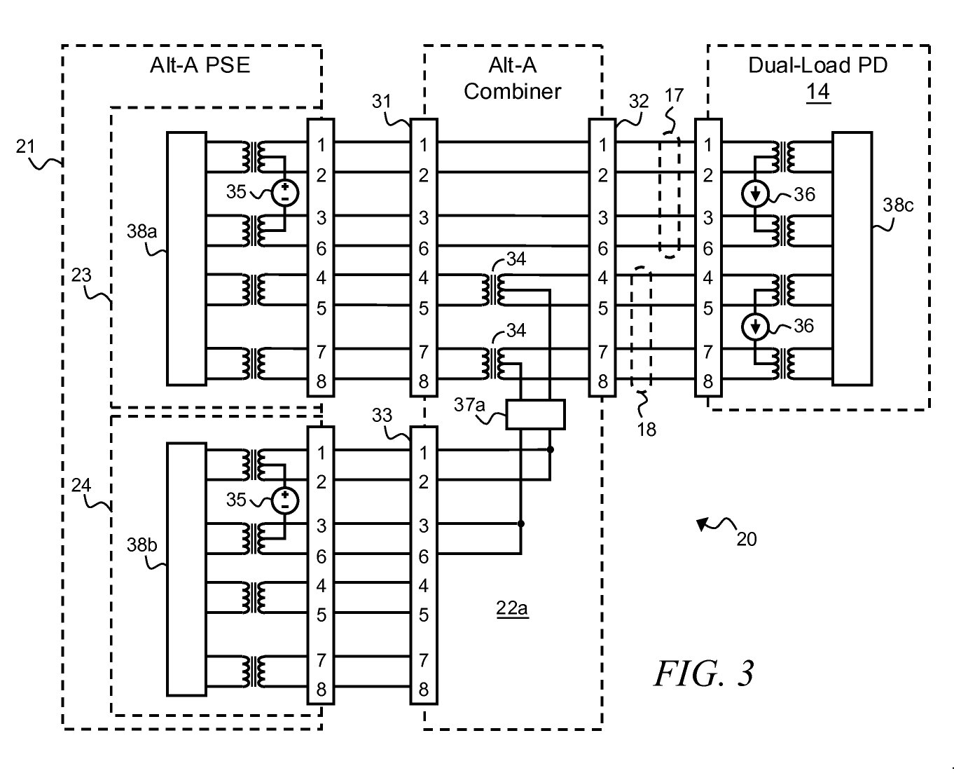

FIG. 3 shows a simplified schematic diagram that reveals portions of the system 20 of FIG. 2 in greater detail. Purely for the purpose of example, all the connectors shown in all the figures are assumed to be of the RJ45 type and the pin numbers shown are as defined in the IEEE standard; thus the Alt-A wires 17 connect with pins 1, 2, 3, and 6 on the RJ45 connectors; and the Alt-B wires 18 connect with pins 4, 5, 7 and 8 on the RJ45 connectors. However, the invention is not limited to this particular case and other suitable connector types and pin number assignments could be substituted.

To simplify the explanation of how the system 20 operates, the detection and classification processes defined by the IEEE standard are skipped, and it is assumed that both ports 23 and 24 of the PSE 21 have successfully detected and classified the dual-load PD 14, and are supplying power to the dual-load PD via the combiner 22a. Thus, the complex PSE power circuits are represented as simple voltage sources 35, and the complex PD load circuits are represented as simple constant-current loads 36.

FIG. 3 illustrates a first embodiment of the present invention where the combiner 22a is adapted for use with an Alt-A PSE 21. Power from the first PSE port 23 is received by the combiner 22a on the Alt-A contacts (pins 1, 2, 3, and 6) of a first connector 31; the power is then passed through the combiner to a second connector 32; and thence to the Alt-A inputs of the dual-load PD 14. Power from the second PSE port 24 is received by the combiner 22a on the Alt-A contacts of a third connector 33, transferred to the Alt-B contacts of the second connector 32 via a common-mode filter 37a and transformers 34, and thence to the Alt-B inputs (pins 4, 5, 7 and 8) of the dual-load PD 14.

The transformers 34 also serve to block DC voltage from the source 35 of the second PSE port 24 from reaching the Alt-B contacts (pins 4, 5, 7 and 8) of connector 31 for several reasons: first, there may be components, such as common-mode terminations (not shown in FIG. 3), connected to pins 4, 5, 7 and 8 inside the first PSE port 23 that could be damaged by the DC voltage; and second, the transformers 34 prevent the common-mode output impedance of the first PSE port 23 from interferring with the detection and classification processes of the second PSE port 24.

Ethernet data in the form of differential-mode signals is passed between the transceivers 38a and 38c on the four twisted-pairs 17 and 18. Transformers 34 provide AC-coupling for the signals on two of these twisted pairs 18. Data signals from the third transceiver 38b are short-circuited inside the combiner 22a so that these signals won't interfere with the communications between 38a and 38c.

One purpose of the common-mode filter 37a is to attenuate common-mode reflections that could cause radiated emissions from the network cables. However, it is essential that the combiner not interfere with the ability of the PSE ports 23 and 24 to detect when the dual-load PD 14 is disconnected. The IEEE standard defines a method for sensing when a PD is physically disconnected from the PSE, the method comprising steps: the PSE superimposes a small common-mode AC voltage (or current) signal on the dc power; the PSE monitors the resulting AC current (or voltage); the PSE determines impedance from the ratio of the AC voltage to AC current; the PSE determines that the PD has been disconnected when the impedance exceeds a threshold defined in the IEEE standard; and subsequent to the impedance exceeding the threshold for a predetermined length of time, the PSE turns off power to the PD. When the combiner 22a is used, the PSE still sees the impedance of the combiner after the dual-load PD 14 has been removed. The impedance of the combiner seen by the voltage source 35 in the second PSE port 24 must be at least several megaohms; therefore, the common-mode filter 37a must have small input capacitance.

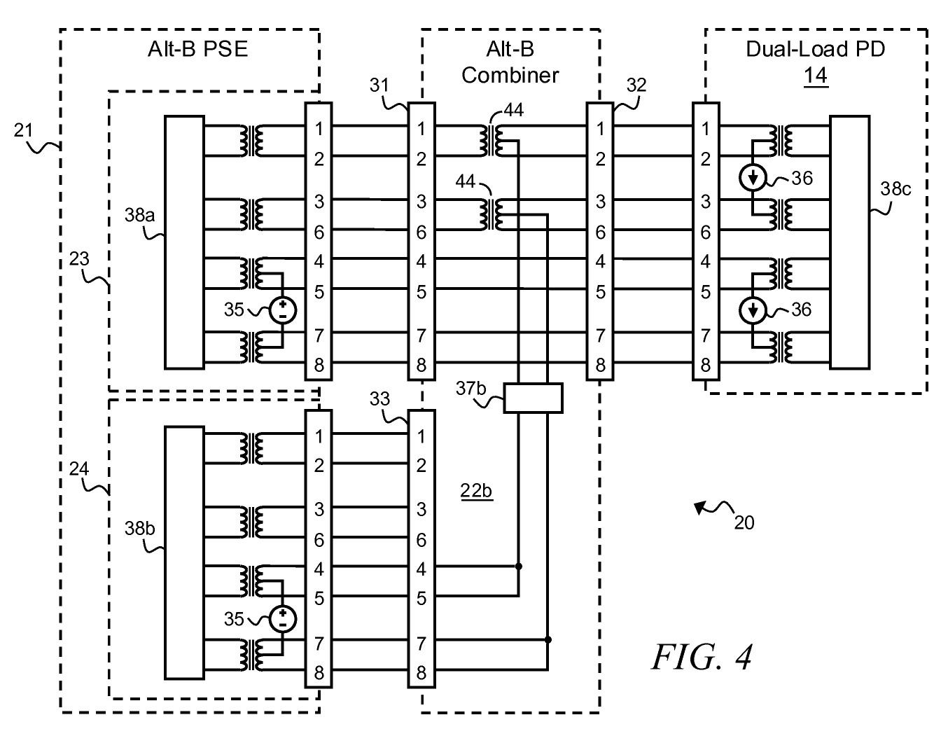

FIG. 4 shows another embodiment of the present invention, where two ports 23 and 24 on an Alt-B PSE 21 are passively combined by combiner 22b. Power from the first PSE port 23 is received by the combiner 22b on the Alt-B contacts of a first connector 31; the power is then passed through the combiner to a second connector 32; and thence to the Alt-B inputs of the dual-load PD 14. Power from the second PSE port is received by the combiner on the Alt-B contacts of a third connector 33, transferred to the Alt-A contacts of the second connector 32 via common-mode filter 37b and transformers 44, and thence to the Alt-A inputs of the dual-load PD 14.

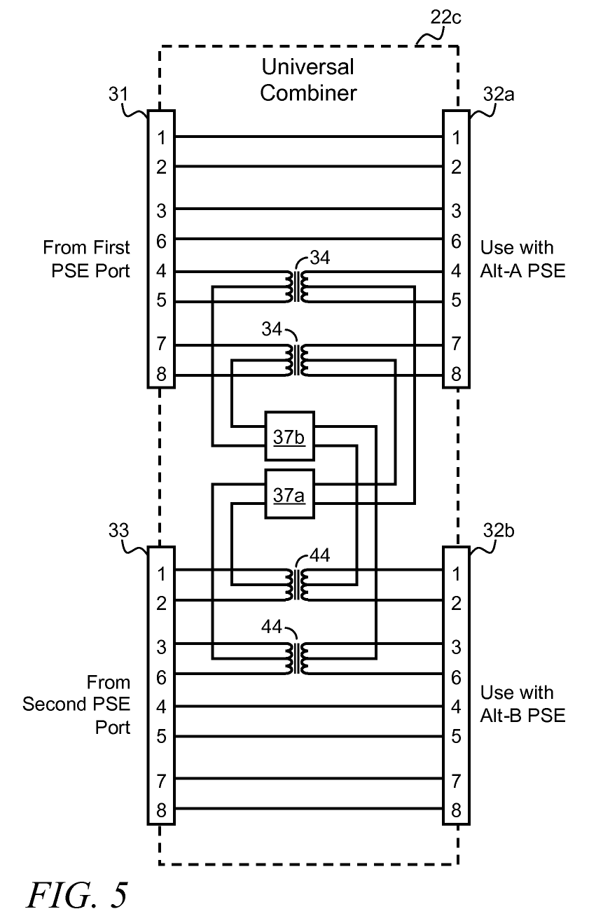

FIG. 5 shows yet another embodiment where the schematics of FIG. 3 and FIG. 4 are combined into a single universal combiner that works with any PSE type, Alt-A or Alt-B. The two PSE ports interface with connectors 31 and 33. If the PSE uses Alt-A (like the PSE of FIG. 3) then the PD is connected to 32a and connector 32b is unused. However, if the PSE uses Alt-B (like the PSE of FIG. 4) then the PD is connected to 32b and connector 32a is unused.

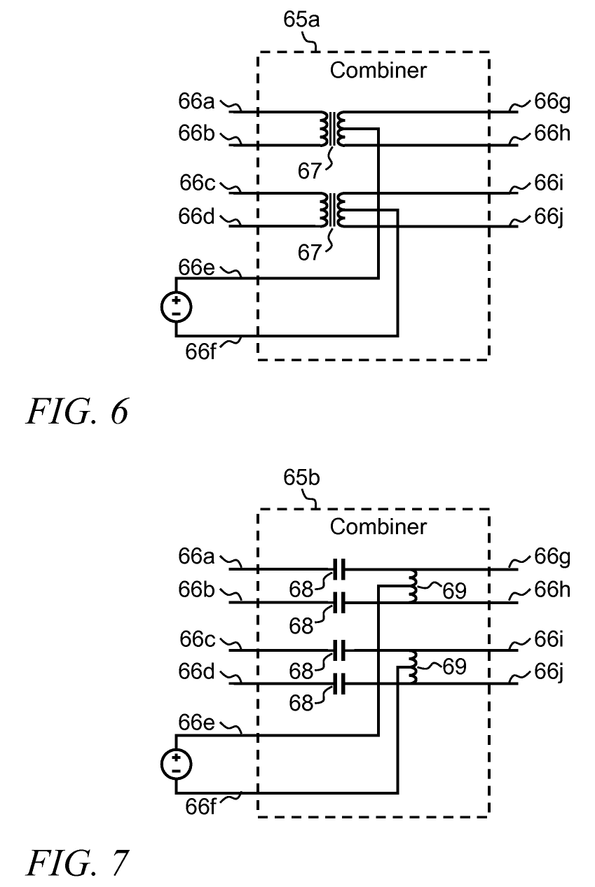

The several embodiments described so far all utilize transformers to DC-couple common-mode power while simultaneously AC-coupling differential-mode data signals as depicted in FIG. 6, but other embodiments utilize alternative circuitry, FIG. 7 illustrating one such alternative for example. FIG. 6 shows a first circuit 65a that utilizes transformers 67 to inject common-mode DC power from the source onto wires 66g through 66j while simultaneously blocking common-mode DC power from wires 66a through 66d. FIG. 7 shows a second circuit 46b that utilizes center-tapped inductors (chokes) 69 to inject the common-mode DC power onto wires 66g through 66j, and DC-blocking capacitors 68 to block power on wires 66a through 66d. The two circuits 45a and 45b accomplish the same functions, therefore the schematics of FIG. 3, FIG. 4, and FIG. 5 could be redrawn with capacitors and chokes instead of transformers.

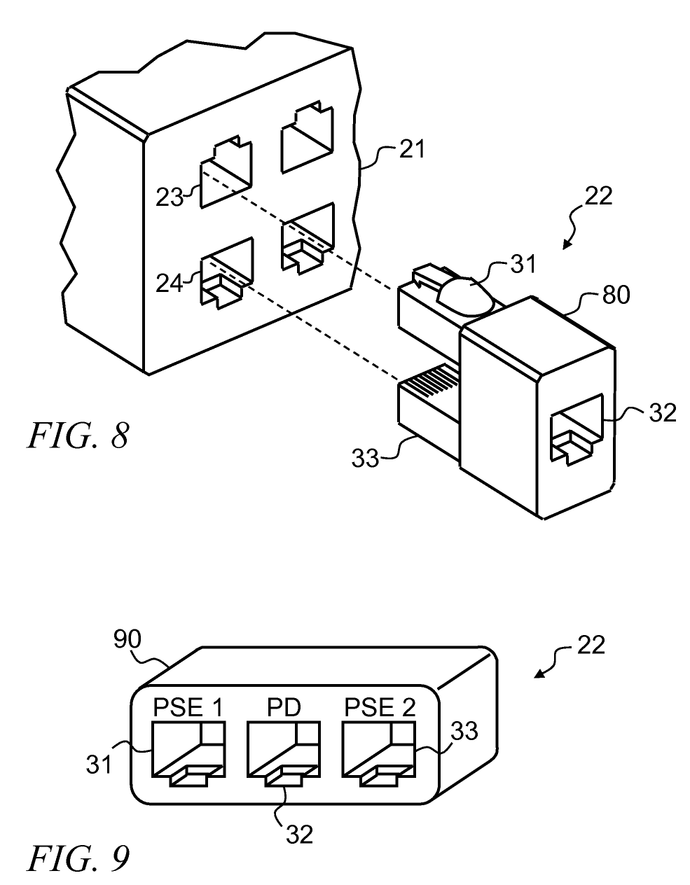

FIG. 8 shows a mechanical embodiment of the invention, wherein the combiner circuit 22 is packaged within the housing 80 with several connectors. As the dashed-lines indicate, the two plugs 31 and 33 mate with two receptacles (23 and 24 respectively) on the front panel of a PSE 21, and a network cable plugs into the receptacle 32, the other end of the network cable being attached to a dual-load PD.

FIG. 9 shows another mechanical embodiment of the invention, wherein the combiner circuit 22 is packaged within the housing 90. In this embodiment, all three connectors 31, 32, and 33 are receptacles for standard Ethernet cables to plug into, and the connectors are labeled “PSE 1”, “PD”, and “PSE 2” respectively on the front panel of the unit to assist users in connecting the cables correctly. No physical damage can result if the cables are connected incorrectly, because the IEEE standard includes safeguards for the scenario where two PSE outputs are connected together.

Yet another mechanical embodiment packages the invention in the form of a patch panel, with a plurality of similar circuits.

Although the present invention has been described with several embodiments, a myriad of changes, variations, alterations, transformations, and modifications may be suggested by one skilled in the art, and it is intended that the present invention encompass such changes, variations, alterations, transformations, and modifications as they fall within the scope of the appended claims. Some obvious changes, variations, alterations, transformations, and modifications include: deleting some of the transformers or center-tapped chokes to reduce cost in a combiner that supports only 10Base-T or 100Base-Tx; or using center-tapped chokes in combination with transformers, where the center-tapped chokes handle the DC-coupling of common-mode power and the transformers handle the AC-coupling of differential-mode data signals; or adding terminations on any unused lines to reduce reflections or radiated emissions.

What is claimed is:

1. A method for combining power from two ports of a Power Sourcing Equipment (PSE) onto a single network cable, said PSE comprising a first PSE port and a second PSE port, said network cable comprising a first set of two conductor pairs and a second set of two conductor pairs, the method comprising the steps of:
transferring DC power from said first PSE port to said first set of two conductor pairs within said network cable;
transferring DC power from said second PSE port to said second set of two conductor pairs within said network cable;
blocking the flow of DC power between said first PSE port and said second PSE port;
transferring differential-mode data signals between said first PSE port and said network cable; and
blocking differential-mode data signals from said second PSE port.

2. An apparatus for combining power from two ports of a Power Sourcing Equipment (PSE) onto a single network cable, said PSE having a first PSE port and a second PSE port, said apparatus comprising:
a first connector, providing an interface to said first PSE port;
a second connector, providing an interface to said second PSE port;
a third connector, providing an interface to said network cable; and
circuitry that DC-couples power from said first connector to said third connector, said circuitry also DC-coupling power from said second connector to said third connector, said circuitry also blocking the flow of DC power between said first connector and said second connector, and said circuitry also AC-coupling differential-mode data signals between said first connector and said third connector.

3. The apparatus of claim 2, wherein said circuitry comprises:
at least one transformer, each said transformer further comprising at least one primary winding connected to said first connector, and at least one secondary winding connected to said third connector; and
a plurality of circuit pathways arranged to DC-couple power from said second connector to said third connector via the secondary windings of said transformers.

4. The apparatus of claim 3, embodied in the form of an assembly where said first connector and said second connector plug directly into said two ports of said PSE.

5. At least one of the apparatus of claim 3 aggregated into a patch panel assembly.

6. The apparatus of claim 3, wherein said circuit pathways comprise common-mode chokes.

7. The apparatus of claim 2, wherein said circuitry comprises:
a plurality of capacitors arranged to AC-couple differential-mode data signals between said first connector and said third connector; and
a plurality of inductors (chokes) arranged to DC-couple power from said second connector to third second connector.

8. The apparatus of claim 7, embodied in the form of an assembly where said first connector and said second connector plug directly into said two ports of said PSE.

9. At least one of the apparatus of claim 7 aggregated into a patch panel assembly.

10. An apparatus for combining power from two ports of a Power Sourcing Equipment (PSE) onto a single network cable, said PSE having a first PSE port and a second PSE port, said apparatus comprising:
a first connector, providing an interface to said first PSE port;
a second connector, providing an interface to said second PSE port;
a third connector, providing an interface to said network cable;
a fourth connector, providing an alternate interface to said network cable; and
circuitry that DC-couples power from said first connector and said second connector to said third connector, said circuitry also DC-coupling power from said first connector and said second connector to said fourth connector, said circuitry also blocking the flow of DC power between said first connector and said second connector, said circuitry also AC-coupling differential-mode data signals between said first connector and said third connector, and said circuitry also AC-coupling differential-mode data signals between said second connector and said fourth connector.

11. The apparatus of claim 10, wherein said circuitry comprises:
a first group of transformers, each transformer in said first group further comprising at least one primary winding connected to said first connector, and at least one secondary winding connected to said third connector;
a second group of transformers, each transformer in said second group further comprising at least one primary winding connected to said second connector, and at least one secondary winding connected to said fourth connector;
a plurality of circuit pathways arranged to DC-couple power from said primary windings of said first group of transformers, to said secondary windings of said second group of transformers; and
a plurality of circuit pathways arranged to DC-couple power from said primary windings of said second group of transformers, to said secondary windings of said first group of transformers.

12. The apparatus of claim 11, embodied in the form of an assembly where said first connector and said second connector plug directly into said two ports of said PSE.

13. At least one of the apparatus of claim 11 aggregated into a patch panel assembly.

14. The apparatus of claim 11, wherein said circuit pathways comprise common-mode chokes.

15. The apparatus of claim 10, wherein said circuitry comprises:
a plurality of capacitors arranged to AC-couple differential-mode data signals between said first connector and said third connector;
a plurality of capacitors arranged to AC-couple differential-mode data signals between said second connector and said fourth connector;
a plurality of inductors (chokes) arranged to DC-couple power from said second connector to said third connector; and
a plurality of inductors (chokes) arranged to DC-couple power from said first connector to said fourth connector.

16. The apparatus of claim 14, embodied in the form of an assembly where said first connector and said second connector plug directly into said two ports of said PSE.

17. The apparatus of claim 14, wherein said circuit pathways comprise common-mode chokes.
